(19) United States
(12) Patent Application Publication
(10) Pub. No.: US 2010/0082506 A1
(43) Pub. Date: Apr. 1, 2010

(54) Active Electronic Medical Record Based Support System Using Learning Machines

(75) Inventors: Gopal B. Avinash, Menomonee Falls, WI (US); Suresh K. Choubcy, Delafield, WI (US); Saad Ahmed Sirohey, Pewaukee, WI (US); Stephen W. Metz, Greenfield, WI (US); David M. Deaven, Delafield, WI (US); Michael J. Barber, Mequon, WI (US)

Correspondence Address: GE HEALTHCARE;c/o FLETCHER YODER, PC, P.O. BOX 692289, HOUSTON, TX, 77269-2289, US

(73) Assignee: General Electric Company, Schenectady, NY (US)

(21) Appl. No.: 12/242,319

(22) Filed: Sep. 30, 2008

(51) Int. Cl. G06F 15/18

(52) U.S. Cl. 706/12

(57) ABSTRACT

A data processing technique is provided. In one embodiment, a computer-implemented method includes receiving image data from an imaging system and organizing the image data into multiple objects of interest. The method may also include identifying source-invariant features of the multiple objects of interest and classifying the multiple objects of interest via a learning algorithm into categories based, at least in part, on the identified source-invariant features. Further, the method may include outputting a report based at least in part on data derived from the classification of one or more of the multiple objects of interest. Additional methods, systems, and devices are also disclosed.

### BACKGROUND

The invention relates generally to the field of medical data processing and, more specifically, to techniques for training and using learning machines.

In the medical field, many different tools are available for learning about and treating patient conditions. Traditionally, physicians would physically examine patients and draw upon a vast array of personal knowledge gleaned from years of study and experience to identify problems and conditions experienced by patients, and to determine appropriate treatments. Sources of support information traditionally included other practitioners, reference books and manuals, relatively straightforward examination results and analyses, and so forth. Over the past decades, and particularly in recent years, a wide array of further reference materials and decision support tools have become available to the practitioner that greatly expand the resources available and enhance and improve patient care.

For instance, vast amounts of information related to a patient, such as identifying information, medical history, test results, image data, and the like, may be collected and stored in electronic form in an electronic medical record (EMR) for that patient. Such EMRs may improve the decision-making process of a clinician by providing all, or a substantial portion, of relevant patient data to the clinician in an efficient manner, rather than requiring the clinician to collect data from multiple locations and sources. Further, it may be appreciated that the collection of relevant patient data in a central location, such as an EMR, may facilitate the development of decision-support tools to aid the clinician in diagnosing and treating a patient. An “active” EMR, for instance, uses the data in the EMR in a processing algorithm to provide support to the clinician in a decision-making process.

One exemplary processing algorithm can be a learning algorithm for classifying objects based on their features to solve problems of interest. It will be appreciated, however, that the development of such a learning algorithm, including the training and testing of the learning algorithm, is typically a lengthy process. Moreover, such learning algorithms often depend on data characteristics particular to the data acquisition system with which the data was obtained. Consequently, learning algorithms are seldom used in medical applications due to the fact that medical technology rapidly evolves and that learning algorithms trained and tested based on data previously gathered may no longer be applicable to current data acquired with newer or different technologies.

### BRIEF DESCRIPTION

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

Embodiments of the present invention may generally relate to techniques for training a learning algorithm or machine and for processing data with such an algorithm or machine. In one embodiment, a learning machine is trained, tested, and validated through a data driven process. In another embodiment, data is received from one or more data acquisition systems, and acquisition source-invariant features are derived from the data and subsequently processed by a learning algorithm to provide decision-making support to a user. Particularly, in one embodiment, the process provides decision-making support to a clinician in diagnosing a patient.

Various refinements of the features noted above may exist in relation to various aspects of the present invention. Further features may also be incorporated in these various aspects as well. These refinements and additional features may exist individually or in any combination. For instance, various features discussed below in relation to one or more of the illustrated embodiments may be incorporated into any of the above-described aspects of the present invention alone or in any combination. Again, the brief summary presented above is intended only to familiarize the reader with certain aspects and contexts of the present invention without limitation to the claimed subject matter.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an exemplary processor-based device or system in accordance with one embodiment of the present invention;

FIG. 2 is a block diagram generally depicting the operation of an exemplary system including a data acquisition system and a data processing system in accordance with one embodiment of the present invention;

FIG. 3 is a general diagrammatical representation of an exemplary data acquisition resource of FIG. 2, which includes various general components or modules for acquiring electrical data representative of body function and state;

FIG. 4 is a general diagrammatical representation of certain functional components of a medical diagnostic imaging system that may be part of a data acquisition resource in accordance with one embodiment of the present invention;

FIG. 5 is a diagrammatical representation of an exemplary X-ray imaging system which may be employed in accordance with one embodiment of the present invention;

FIG. 6 is a diagrammatical representation of an exemplary magnetic resonance imaging system which may be employed in accordance with one embodiment of the present invention;

FIG. 7 is a diagrammatical representation of an exemplary computed tomography imaging system for use in accordance with one embodiment of the present invention;

FIG. 8 is a diagrammatical representation of an exemplary positron emission tomography system or single photon emission computed tomography system for use in accordance with one embodiment of the present invention;

FIG. 9 is a flow chart of an exemplary data processing method provided in accordance with one embodiment of the present invention;

FIG. 10 is a block diagram illustrating various modules that may be employed to perform the method of FIG. 9 in accordance with one embodiment of the present invention;

FIG. 11 is a flow diagram of a process for providing an output to a user in accordance with one embodiment of the present invention; and

FIG. 12 is a flow diagram of an exemplary method for training and validating a learning machine in accordance with one embodiment of the present invention.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Moreover, while the term “exemplary” may be used herein in connection to certain examples of aspects or embodiments of the presently disclosed technique, it will be appreciated that these examples are illustrative in nature and that the term “exemplary” is not used herein to denote any preference or requirement with respect to a disclosed aspect or embodiment. Further, any use of the terms “top,” “bottom,” “above,” “below,” other positional terms, and variations of these terms is made for convenience, but does not require any particular orientation of the described components.

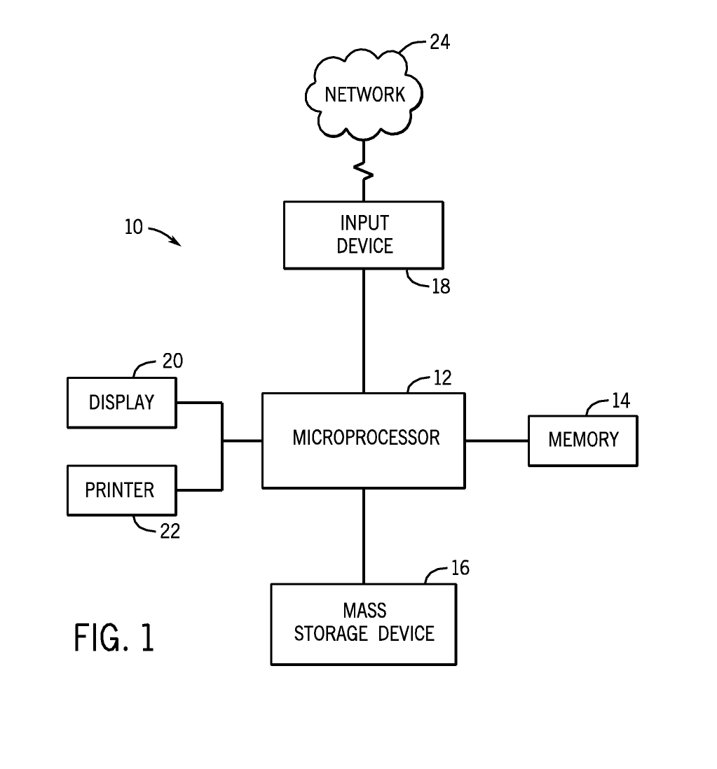

Turning now to the drawings, and referring first to FIG. 1, an exemplary processor-based system 10 for use in conjunction with the present technique is depicted. In one embodiment, the exemplary processor-based system 10 is a general-purpose computer, such as a personal computer, configured to run a variety of software, including software implementing all or part of the present technique. Alternatively, in other embodiments, the processor-based system 10 may comprise, among other things, a mainframe computer, a distributed computing system, or an application-specific computer or workstation configured to implement all or part of the present technique based on specialized software and/or hardware provided as part of the system. Further, the processor-based system 10 may include either a single processor or a plurality of processors to facilitate implementation of the presently disclosed functionality.

In general, the exemplary processor-based system 10 includes a microcontroller or microprocessor 12, such as a central processing unit (CPU), which executes various routines and processing functions of the system 10. For example, the microprocessor 12 may execute various operating system instructions as well as software routines configured to effect certain processes and stored in or provided by a manufacture including a computer readable-medium, such as a memory 14 (e.g., a random access memory (RAM) of a personal computer) or one or more mass storage devices 16 (e.g., an internal or external hard drive, a solid-state storage device, CD-ROM, DVD, or other storage device). In addition, the microprocessor 12 processes data provided as inputs for various routines or software programs, such as data provided as part of the present technique in computer-based implementations.

Such data may be stored in, or provided by, the memory 14 or mass storage device 16. Alternatively, such data may be provided to the microprocessor 12 via one or more input devices 18. As will be appreciated by those of ordinary skill in the art, the input devices 18 may include manual input devices, such as a keyboard, a mouse, or the like. In addition, the input devices 18 may include a network device, such as a wired or wireless Ethernet card, a wireless network adapter, or any of various ports or devices configured to facilitate communication with other devices via any suitable communications network 24, such as a local area network or the Internet. Through such a network device, the system 10 may exchange data and communicate with other networked electronic systems, whether proximate to or remote from the system 10. It will be appreciated that the network 24 may include various components that facilitate communication, including switches, routers, servers or other computers, network adapters, communications cables, and so forth.

Results generated by the microprocessor 12, such as the results obtained by processing data in accordance with one or more stored routines, may be provided to an operator via one or more output devices, such as a display 20 and/or a printer 22. Based on the displayed or printed output, an operator may request additional or alternative processing or provide additional or alternative data, such as via the input device 18. As will be appreciated by those of ordinary skill in the art, communication between the various components of the processor-based system 10 may typically be accomplished via a chipset and one or more busses or interconnects which electrically connect the components of the system 10. Notably, in certain embodiments of the present technique, the exemplary processor-based system 10 may be configured to process data and to classify objects in the data with a learning algorithm, as discussed in greater detail below.

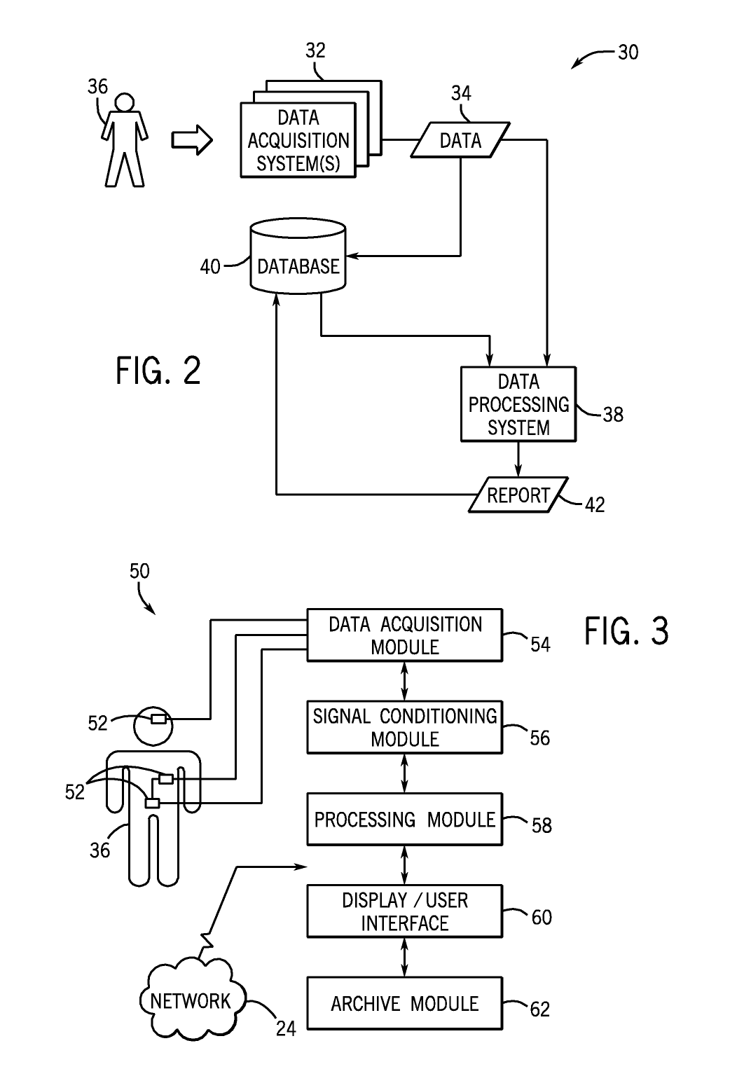

An exemplary system 30 for acquiring and processing data in accordance with one embodiment of the present invention is illustrated in FIG. 2. The system 30 includes one or more data acquisition systems 32 that collect data 34 from, or regarding, a patient 36. The data 34 may include either or both of image data and non-image data, which may include, among other things, electronic medical record (EMR) meta-data. Further, the data 34 may be received from static or dynamic data sources, including the data acquisition systems 32, and processed by a data processing system 38. The data processing system 38 may include the processor-based system 10 discussed above, or any other or additional components or systems that facilitate data processing in accordance with the presently disclosed technique.

It will be appreciated that the data 34 may be stored in a database 40, and that the data processing system 38 may receive the data 34 directly from the data acquisition systems 32, from the database 40, or in any other suitable fashion. Further, the data processing system 38 may also receive additional data from the database 40 for processing. As discussed in greater detail below, the processing performed by the data processing system 38 may include organizing the data 34 or additional data into multiple objects based on a problem of interest, deriving source-invariant features from the organized data, classifying the objects based on the source-invariant features, organizing the results to facilitate solving of the problem of interest, and outputting some indication of the results, as generally indicated by the report 42 in FIG. 2. It should be noted that the data processing system 38 may be a processor-based system such as that illustrated in FIG. 1, and may include any suitable combination of hardware and/or software adapted to perform the presently disclosed functionality. Further, while certain embodiments of the present technique may be discussed with respect to medical data and devices, it is noted that the use of the present technique with non-medical data and systems is also envisaged.

While additional details of the operation of a data processing system 38 in accordance with certain embodiments are provided below, it is first noted that the presently disclosed techniques are applicable to data obtained from a wide array of data sources (e.g., data acquisition systems 32) and having varying characteristics and formats that may depend on the type of data source from which the data is obtained. In some embodiments, an exemplary data acquisition system 50 may include certain typical modules or components as indicated generally in FIG. 3. These components may include sensors or transducers 52, which may be placed on or about a patient to detect certain parameters of interest that may be indicative of medical events or conditions. Thus, the sensors may detect electrical signals emanating from the body or portions of the body, pressure created by certain types of movement (e.g. pulse, respiration), or parameters such as movement, reactions to stimuli, and so forth. The sensors 52 may be placed on external regions of the body, but may also include placement within the body, such as through catheters, injected or ingested means, capsules equipped with transmitters, and so forth.

The sensors generate signals or data representative of the sensed parameters. Such raw data may be transmitted to a data acquisition module 54. The data acquisition module may acquire sampled or analog data, and may perform various initial operations on the data, such as filtering, multiplexing, and so forth. The data may then be transmitted to a signal conditioning module 56 where further processing is performed, such as for additional filtering, analog-to-digital conversion, and so forth. A processing module 58 then receives the data and performs processing functions, which may include simple or detailed analysis of the data. A display/user interface 60 permits the data to be manipulated, viewed, and output in a user-desired format, such as in traces on screen displays, hardcopy, and so forth. The processing module 58 may also mark or analyze the data for marking such that annotations, delimiting or labeling axes or arrows, and other indicia may appear on the output produced via interface 60. Finally, an archive module 62 serves to store the data either locally within the resource, or remotely. The archive module may also permit reformatting or reconstruction of the data, compression of the data, decompression of the data, and so forth. The particular configuration of the various modules and components illustrated in FIG. 3 will, of course, vary depending upon the nature of the resource and, if an imaging system, the modality involved. Finally, as represented generally at reference numeral 24, the modules and components illustrated in FIG. 3 may be directly or indirectly linked to external systems and resources via a network, which may facilitate transmission of data 34 from the data acquisition system 32 to the data processing system 38 or the database 40.

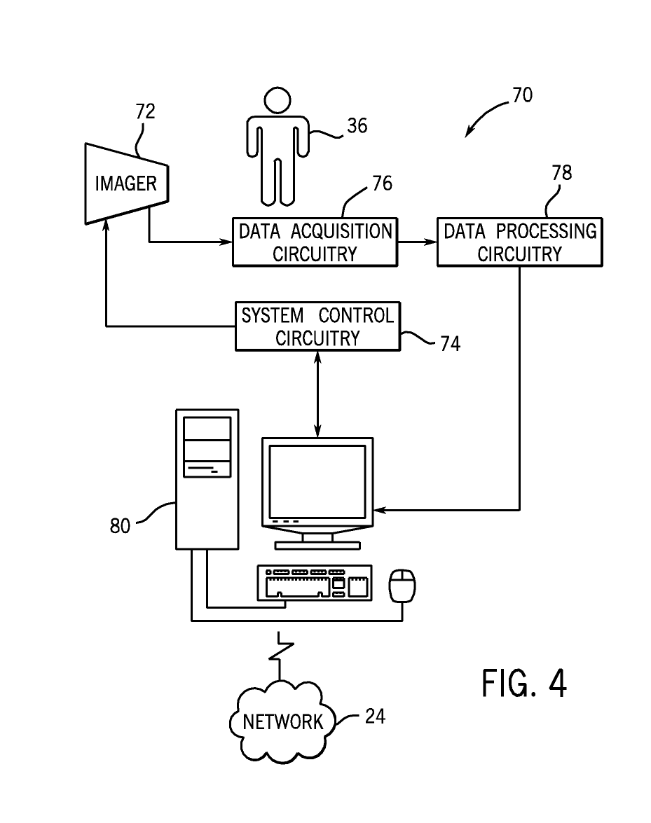

It will be appreciated that the data acquisition systems 32 may include a number of non-imaging systems capable of collecting desired data from a patient. For instance, the data acquisition systems 32 may include, among others, an electroencephalography (EEG) system, an electrocardiography (ECG or EKG) system, an electromyography (EMG) system, an electrical impedance tomography (EIT) system, an electronystagmography (ENG) system, a system adapted to collect nerve conduction data, or some combination of these systems. The data acquisition systems may also or instead include various imaging resources, as discussed below with respect to FIGS. 4-8.

It will be appreciated that such imaging resources may be employed to diagnose medical events and conditions in both soft and hard tissue, and for analyzing structures and function of specific anatomies. Moreover, imaging systems are available which can be used during surgical interventions, such as to assist in guiding surgical components through areas which are difficult to access or impossible to visualize. FIG. 4 provides a general overview for exemplary imaging systems, and subsequent figures offer somewhat greater detail into the major system components of specific modality systems.

Referring to FIG. 4, an imaging system 70 generally includes some type of imager 72 which detects signals and converts the signals to useful data. As described more fully below, the imager 72 may operate in accordance with various physical principles for creating the image data. In general, however, image data indicative of regions of interest in a patient are created by the imager either in a conventional support, such as photographic film, or in a digital medium.

The imager operates under the control of system control circuitry 74. The system control circuitry may include a wide range of circuits, such as radiation source control circuits, timing circuits, circuits for coordinating data acquisition in conjunction with patient or table of movements, circuits for controlling the position of radiation or other sources and of detectors, and so forth. The imager 72, following acquisition of the image data or signals, may process the signals, such as for conversion to digital values, and forwards the image data to data acquisition circuitry 76. In the case of analog media, such as photographic film, the data acquisition system may generally include supports for the film, as well as equipment for developing the film and producing hard copies that may be subsequently digitized. For digital systems, the data acquisition circuitry 76 may perform a wide range of initial processing functions, such as adjustment of digital dynamic ranges, smoothing or sharpening of data, as well as compiling of data streams and files, where desired. The data is then transferred to data processing circuitry 78 where additional processing and analysis are performed. For conventional media such as photographic film, the data processing system may apply textual information to films, as well as attach certain notes or patient-identifying information. For the various digital imaging systems available, the data processing circuitry perform substantial analyses of data, ordering of data, sharpening, smoothing, feature recognition, and so forth.

Ultimately, the image data is forwarded to some type of operator interface 80 for viewing and analysis. While operations may be performed on the image data prior to viewing, the operator interface 80 is at some point useful for viewing reconstructed images based upon the image data collected. It should be noted that in the case of photographic film, images are typically posted on light boxes or similar displays to permit radiologists and attending physicians to more easily read and annotate image sequences. The images may also be stored in short or long term storage devices, for the present purposes generally considered as included within the interface 80, such as picture archiving communication systems. The image data can also be transferred to remote locations, such as a remote data processing system 38, via the network 24. It should also be noted that, from a general standpoint, the operator interface 80 affords control of the imaging system, typically through interface with the system control circuitry 74. Moreover, it should also be noted that more than a single operator interface 80 may be provided. Accordingly, an imaging scanner or station may include an interface which permits regulation of the parameters involved in the image data acquisition procedure, whereas a different operator interface may be provided for manipulating, enhancing, and viewing resulting reconstructed images.

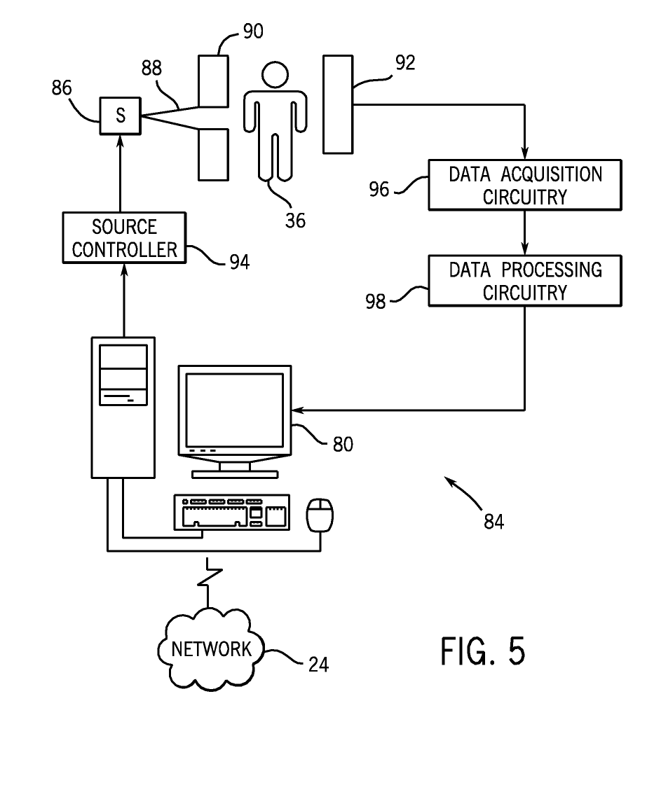

Turning to more detailed examples of imaging systems that may be employed in conjunction with the present technique, a digital X-ray system 84 is generally depicted in FIG. 5. It should be noted that, while reference is made in FIG. 5 to a digital system, conventional X-ray systems may, of course, be employed in the present technique. In particular, conventional X-ray systems may offer extremely useful tools both in the form of photographic film, and digitized image data extracted from photographic film, such as through the use of a digitizer.

System 84 illustrated in FIG. 5 includes a radiation source 86, typically an X-ray tube, designed to emit a beam 88 of radiation. The radiation may be conditioned or adjusted, typically by adjustment of parameters of the source 86, such as the type of target, the input power level, and the filter type. The resulting radiation beam 88 is typically directed through a collimator 90 which determines the extent and shape of the beam directed toward patient 36. A portion of the patient 36 is placed in the path of beam 88, and the beam impacts a digital detector 92.

Detector 92, which typically includes a matrix of pixels, encodes intensities of radiation impacting various locations in the matrix. A scintillator converts the high energy X-ray radiation to lower energy photons which are detected by photodiodes within the detector. The X-ray radiation is attenuated by tissues within the patient, such that the pixels identify various levels of attenuation resulting in various intensity levels which will form the basis for an ultimate reconstructed image.

Control circuitry and data acquisition circuitry are provided for regulating the image acquisition process and for detecting and processing the resulting signals. In particular, in the illustration of FIG. 5, a source controller 94 is provided for regulating operation of the radiation source 86. Other control circuitry may, of course, be provided for controllable aspects of the system, such as a table position, radiation source position, and so forth. Data acquisition circuitry 96 is coupled to the detector 92 and permits readout of the charge on the photodetectors following an exposure. In general, charge on the photodetectors is depleted by the impacting radiation, and the photodetectors are recharged sequentially to measure the depletion. The readout circuitry may include circuitry for systematically reading rows and columns of the photodetectors corresponding to the pixel locations of the image matrix. The resulting signals are then digitized by the data acquisition circuitry 96 and forwarded to data processing circuitry 98.

The data processing circuitry 98 may perform a range of operations, including adjustment for offsets, gains, and the like in the digital data, as well as various imaging enhancement functions. The resulting data is then forwarded to an operator interface, the data processing system 38, or a storage device for short or long-term storage. The images reconstructed based upon the data may be displayed on the operator interface, or may be forwarded to other locations, such as via a network 24 for viewing or additional processing. Also, digital data may be used as the basis for exposure and printing of reconstructed images on a conventional hard copy medium such as photographic film.

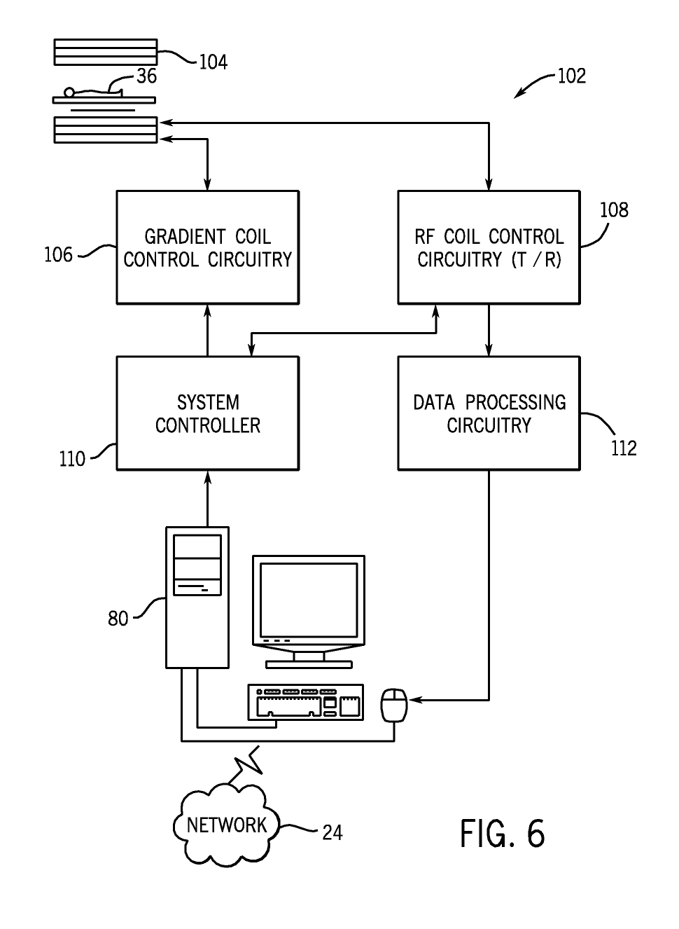

FIG. 6 represents a general diagrammatical representation of a magnetic resonance imaging system 102. The system includes a scanner 104 in which a patient is positioned for acquisition of image data. The scanner 104 generally includes a primary magnet for generating a magnetic field which influences gyromagnetic materials within the body of a patient 36. As the gyromagnetic material, typically water and metabolites, attempts to align with the magnetic field, gradient coils produce additional magnetic fields which are orthogonally oriented with respect to one another. The gradient fields effectively select a slice of tissue through the patient for imaging, and encode the gyromagnetic materials within the slice in accordance with phase and frequency of their rotation. A radio-frequency (RF) coil in the scanner generates high frequency pulses to excite the gyromagnetic material and, as the material attempts to realign itself with the magnetic fields, magnetic resonance signals are emitted which are collected by the radio-frequency coil.

The scanner 104 is coupled to gradient coil control circuitry 106 and to RF coil control circuitry 108. The gradient coil control circuitry permits regulation of various pulse sequences which define imaging or examination methodologies used to generate the image data. Pulse sequence descriptions implemented via the gradient coil control circuitry 106 are designed to image specific slices, anatomies, as well as to permit specific imaging of moving tissue, such as blood, and defusing materials. The pulse sequences may allow for imaging of multiple slices sequentially, such as for analysis of various organs or features, as well as for three-dimensional image reconstruction. The RF coil control circuitry 108 permits application of pulses to the RF excitation coil, and serves to receive and partially process the resulting detected MR signals. It should also be noted that a range of RF coil structures may be employed for specific anatomies and purposes. In addition, a single RF coil may be used for transmission of the RF pulses, with a different coil serving to receive the resulting signals.

The gradient and RF coil control circuitry function under the direction of a system controller 110. The system controller implements pulse sequence descriptions which define the image data acquisition process. The system controller will generally permit some amount of adaptation or configuration of the examination sequence by means of an operator interface 80.

Data processing circuitry 112 receives the detected MR signals and processes the signals to obtain data for reconstruction. In general, the data processing circuitry 112 digitizes the received signals, and performs a two-dimensional fast Fourier transform on the signals to decode specific locations in the selected slice from which the MR signals originated. The resulting information provides an indication of the intensity of MR signals originating at various locations or volume elements (voxels) in the slice. Each voxel may then be converted to a pixel intensity in image data for reconstruction. The data processing circuitry 112 may perform a wide range of other functions, such as for image enhancement, dynamic range adjustment, intensity adjustments, smoothing, sharpening, and so forth. The resulting processed image data is typically forwarded to an operator interface for viewing, as well as to short or long-term storage, or may be forwarded to a data processing system for additional processing. As in the case of foregoing imaging systems, MR image data may be viewed locally at a scanner location, or may be transmitted to remote locations both within an institution and remote from an institution such as via the network 24.

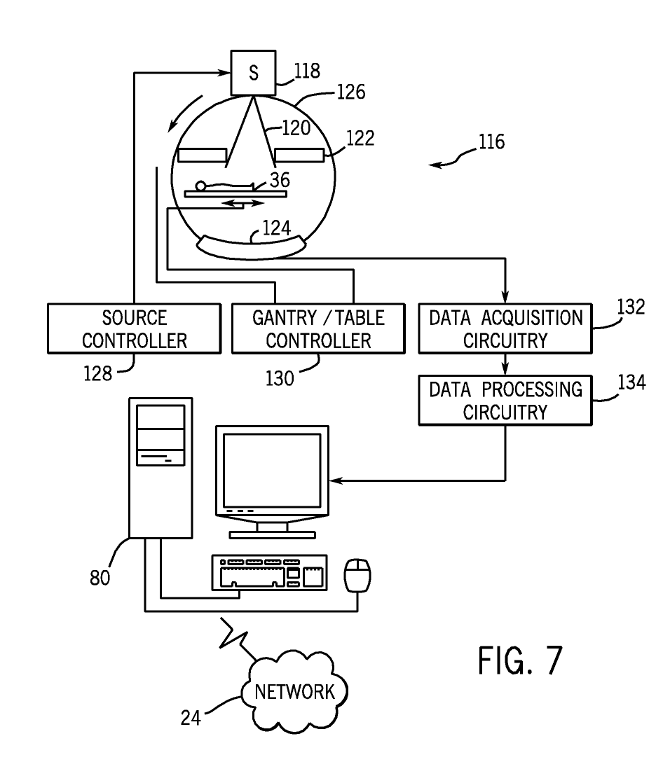

FIG. 7 illustrates the basic components of a computed tomography (CT) imaging system that may be employed as a data acquisition system 32 in accordance with one embodiment. The CT imaging system 116 includes a radiation source 118 which is configured to generate X-ray radiation in a fan-shaped beam 120. A collimator 122 defines limits of the radiation beam. The radiation beam 120 is directed toward a curved detector 124 made up of an array of photodiodes and transistors which permit readout of charges of the diodes depleted by impact of the radiation from the source 118. The radiation source, the collimator and the detector are mounted on a rotating gantry 126 which enables them to be rapidly rotated (such as at speeds of two rotations per second).

During an examination sequence, as the source and detector are rotated, a series of view frames are generated at angularly-displaced locations around a patient 36 positioned within the gantry. A number of view frames (e.g. between 500 and 1000) are collected for each rotation, and a number of rotations may be made, such as in a helical pattern as the patient is slowly moved along the axial direction of the system. For each view frame, data is collected from individual pixel locations of the detector to generate a large volume of discrete data. A source controller 128 regulates operation of the radiation source 118, while a gantry/table controller 130 regulates rotation of the gantry and control of movement of the patient.

Data collected by the detector is digitized and forwarded to a data acquisition circuitry 132. The data acquisition circuitry may perform initial processing of the data, such as for generation of a data file. The data file may incorporate other useful information, such as relating to cardiac cycles, positions within the system at specific times, and so forth. Data processing circuitry 134 then receives the data and performs a wide range of data manipulation and computations.

In general, data from the CT scanner can be reconstructed in a range of manners. For example, view frames for a full 360° of rotation may be used to construct an image of a slice or slab through the patient. However, because some of the information is typically redundant (imaging the same anatomies on opposite sides of a patient), reduced data sets comprising information for view frames acquired over 180° plus the angle of the radiation fan may be constructed. Alternatively, multi-sector reconstructions are utilized in which the same number of view frames may be acquired from portions of multiple rotational cycles around the patient. Reconstruction of the data into useful images then includes computations of projections of radiation on the detector and identification of relative attenuations of the data by specific locations in the patient. The raw, the partially processed, and the fully processed data may be forwarded for post-processing, storage and image reconstruction. The data may be available immediately to an operator, such as at an operator interface 80, and may be transmitted remotely via a network connection 24.

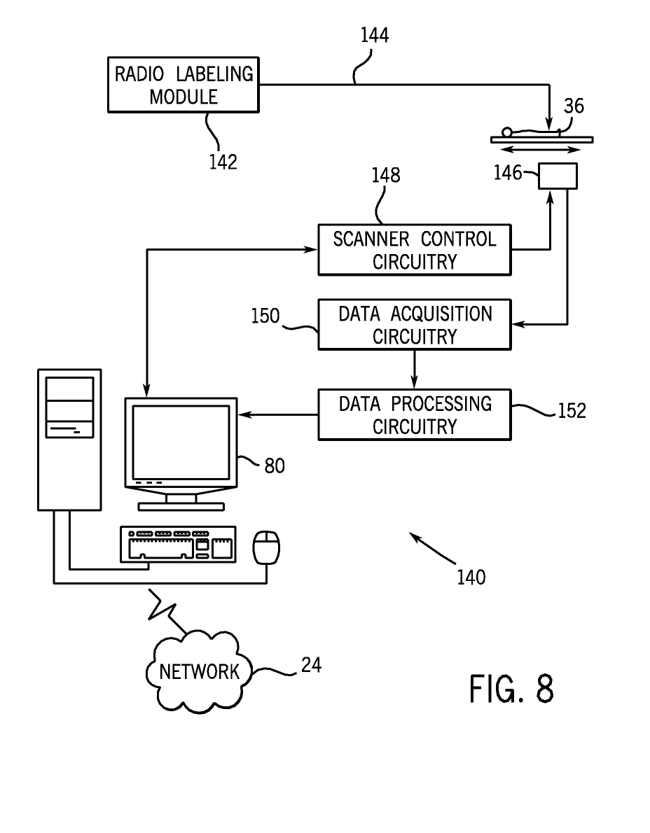

FIG. 8 illustrates certain basic components of a positron emission tomography (PET) imaging system 140. It will be appreciated, however, that the illustrated components could also correspond to those of a single photon emission computed tomography (SPECT) system, which may also be used as a data acquisition system 32. The PET imaging system 140 includes a radio-labeling module 142, which is sometimes referred to as a cyclotron. The cyclotron is adapted to prepare certain tagged or radio-labeled materials, such as glucose, with a radioactive substance. The radioactive substance is then injected into a patient 36 as indicated at reference numeral 144. The patient is then placed in a PET scanner 146. The scanner detects emissions from the tagged substance as its radioactivity decays within the body of the patient. In particular, positrons, sometimes referred to as positive electrons, are emitted by the material as the radioactive nuclide level decays. The positrons travel short distances and eventually combine with electrons resulting in emission of a pair of gamma rays. Photomultiplier-scintillator detectors within the scanner detect the gamma rays and produce signals based upon the detected radiation.

The scanner 146 operates under the control of scanner control circuitry 148, itself regulated by an operator interface 80. In most PET scans, the entire body of the patient is scanned, and signals detected from the gamma radiation are forwarded to data acquisition circuitry 150. The particular intensity and location of the radiation can be identified by data processing circuitry 152, and reconstructed images may be formulated and viewed on operator interface 80, or the raw or processed data may be stored for later image enhancement, analysis, and viewing. The images, or image data, may also be transmitted to remote locations via a link to the network 24.

PET scans are typically used to detect cancers and to examine the effects of cancer therapy. The scans may also be used to determine blood flow, such as to the heart, and may be used to evaluate signs of coronary artery disease. Combined with a myocardial metabolism study, PET scans may be used to differentiate non-functioning heart muscle from heart muscle that would benefit from a procedure, such as angioplasty or coronary artery bypass surgery, to establish adequate blood flow. PET scans of the brain may also be used to evaluate patients with memory disorders of undetermined causes, to evaluate the potential for the presence of brain tumors, and to analyze potential causes for seizure disorders. In these various procedures, the PET image is generated based upon the differential uptake of the tagged materials by different types of tissue.

Although certain imaging systems have been described above for the sake of explanation, it should be noted that the presently disclosed data processing system 38 may process data from additional and/or special-purpose imaging systems, such as a fluorography system, a mammography system, a sonography system, a thermography system, other nuclear medicine systems, or a thermoacoustic system, to name but a few possibilities. Additionally, as noted above, the data processing system 38 may also receive and process additional data obtained from other non-imaging data sources, including that obtained from a database or computer workstation, in full accordance with the present technique.

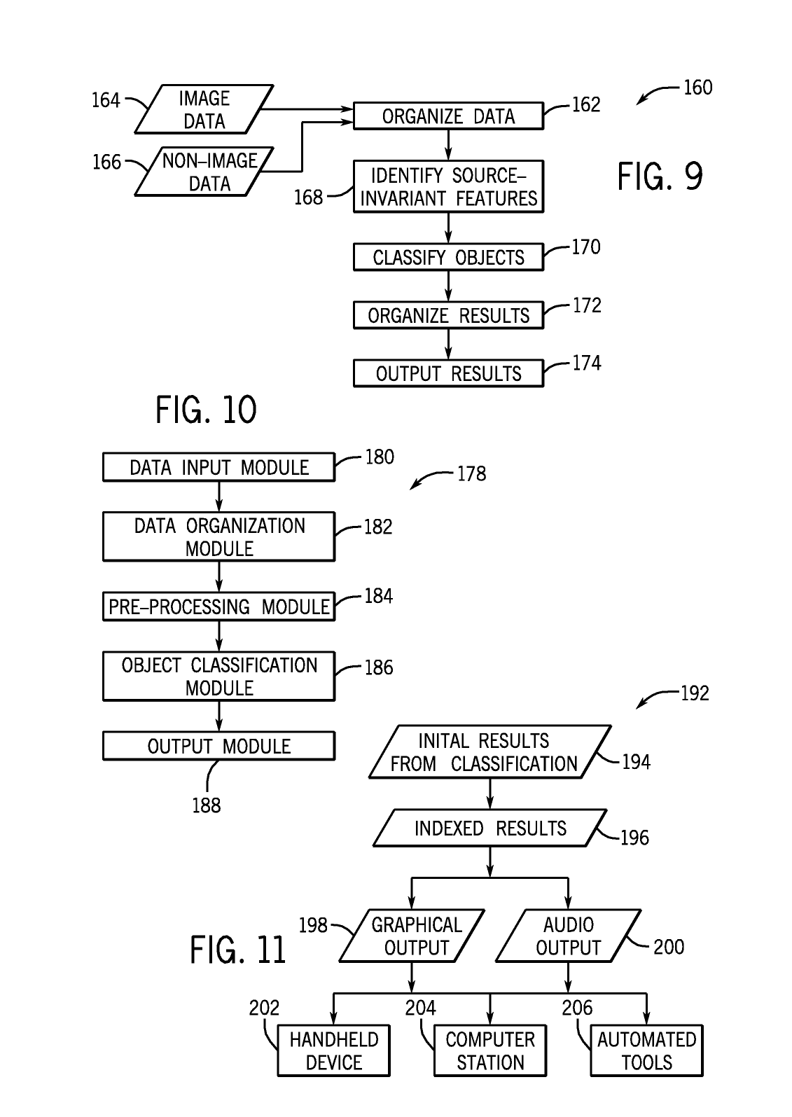

One embodiment of the presently disclosed technique may be better understood with reference to FIG. 9, which depicts a series of steps of an exemplary data processing method 160. Once data is received, such as by the data processing system 38, the data is organized in a step 162. As discussed above, the received data may include one or both of image data 164 and non-image data 166 obtained from any of a wide array of data acquisition systems 32 or databases, such as the database 40. In some embodiments, the non-image data may include parametric data, non-parametric data (e.g., an error event log), or EMR meta-data. In one embodiment, organizing the data may include indexing of text and image information, arranging them as vectors, and mapping the information onto such vectors.

The method 160 also includes a step 168 of identifying source-invariant features in the organized data. As noted above, data collected from a plurality of different acquisition systems may be of different types or have different formats based on the type of acquisition system generating the data. Further, learning machines and learning algorithms are often adapted to receive specific types of data in a specific format, such as that acquired by a single type of data acquisition system (e.g., a CT system, an MRI system, or the like). In various embodiments of the present invention, however, a data processing system may advantageously pre-process the data to identify features in the data that describe objects of interest (e.g., a nodule) in a source-invariant manner. Such features may include, but are not limited to, geometric (i.e., shape) features, textural features, object density, or the like. For instance, in a scenario where the problem of interest is tumor identification and one of the features of a learning algorithm is a sphere having a diameter within a certain range, the data processing system may receive image data from two different data acquisition systems having differing image resolution capabilities, and may be processed differently to derive source-invariant data features.

Once source-invariant features of an object of interest are identified, the exemplary method 160 continues with classification of the objects in step 170. In some embodiments, the objects are classified through use of any suitable learning algorithm or machine. An example of a learning algorithm for classification is a support vector machine. As may be appreciated, support vector machines (SVMs) are a set of related supervised learning methods used for classification and regression and belong to a family of generalized linear classifiers. SVMs can also be considered a special case of Tikhonov regularization. SVMs may simultaneously minimize the empirical classification error and maximize the geometric margin and, consequently, may also be known as maximum margin classifiers.

It is noted again, however, that such learning algorithms and machines are typically trained, tested, and validated based on specific types of data, such as data having a common format from a single data source or similar data sources. Thus, in order to use the learning algorithm or machine with a different type of data other than that used in originally training, testing, and validating the algorithm, the learning algorithm and machine would typically have to be re-trained, re-tested, and re-validated based on a new set of training data. In some embodiments of the presently disclosed technique, however, data features may be pre-processed to describe such features in a source-invariant manner, such that the learning algorithm may classify objects based on source-invariant features obtained from data having different characteristics and received from different data sources. Consequently, the identification of acquisition source-invariant features in the data allows a learning classification algorithm to be broadly applied to a variety of data types from different sources, and may avoid a need to re-train, re-test, and re-validate the algorithm upon changes in data acquisition sources or technologies. Additionally, in some embodiments, the classification of the objects is based not only on image data or source-invariant features of such image data, but also on non-image data received by the data processing system 38. For instance, in one embodiment, the classification may be based on both image data and on non-image data, such as meta-data from an electronic medical record. Also, the results of this classification process may be organized in step 172 prior to any output indicative of the results in step 174, as discussed in greater detail below with respect to FIG. 11.

Various components for carrying out the functionality described above are illustrated in the block diagram 178 of FIG. 10 in accordance with one embodiment of the present invention. Particularly, a data processing system may include a data input module 180 for receiving various data, including one or both of image data 164 and non-image data 166. It is further noted that the data input module 180 may be configured to facilitate automatic collection or receipt of such data over a network, may facilitate user entry of certain types of data, or may otherwise facilitate receipt of data in any other suitable manner. The data processing system may also include a data organization module 182 and a pre-processing module 184, which are configured to organize the data and identify source-invariant features in the data, as generally described above. Additionally, the data processing system may include an object classification module 186 and an output module 188 that are generally configured to classify objects of the data, organize the results in a desired manner, and output an indication of such results. It should be noted that the modules generally illustrated may be embodied in any suitable hardware for performing the presently disclosed functionality, and may also or instead include software routines stored in a manufacture (e.g., a compact disc, a hard drive, a flash memory, RAM, or the like) and configured to be executed by a processor to effect performance of the functionality described herein.

As may be appreciated, multiple people may be interested in the results of the classification process, but may desire different levels of detail with respect to such results. Consequently, in one embodiment generally represented in block diagram 192 of FIG. 11, the classification results are organized in a hierarchial manner that facilitates dissemination of the results to various persons with an appropriate level of detail. In the presently illustrated embodiment, initial classification results 194, which may typically be in the form of numerical and/or text formats, are indexed to produce results 196 that facilitate further analysis or post-processing to generate any desired graphical output 198 or audio output 200, such as an alarm, that provides an indication of the results. In some embodiments, the output of results in step 174 (FIG. 9) may include, or consist entirely of, the provision of the graphical output 198 or the audio output 200. The outputs 198 and 200 may be stored after such post-processing, and the graphical output 198 and/or the audio output 200 may be communicated to one or more desired devices or tools, including a handheld device 202, a computer station 204, automated tools 206, or the like. It will be appreciated that the outputs 198 and 200 may be provided to such devices or tools through any suitable manner, such as through wired communication or wireless communication. Additionally, the indexed results 196, or even the initial results 194, may be provided to the handheld device 202, the computer station 204, or the automated tools 206 if desired. For instance, in one embodiment, the handheld device 202 may receive the graphical output 198 or the audio output 200 and a user of such device may choose to access the initial results 194 or the indexed results 196 via the handheld device 202.

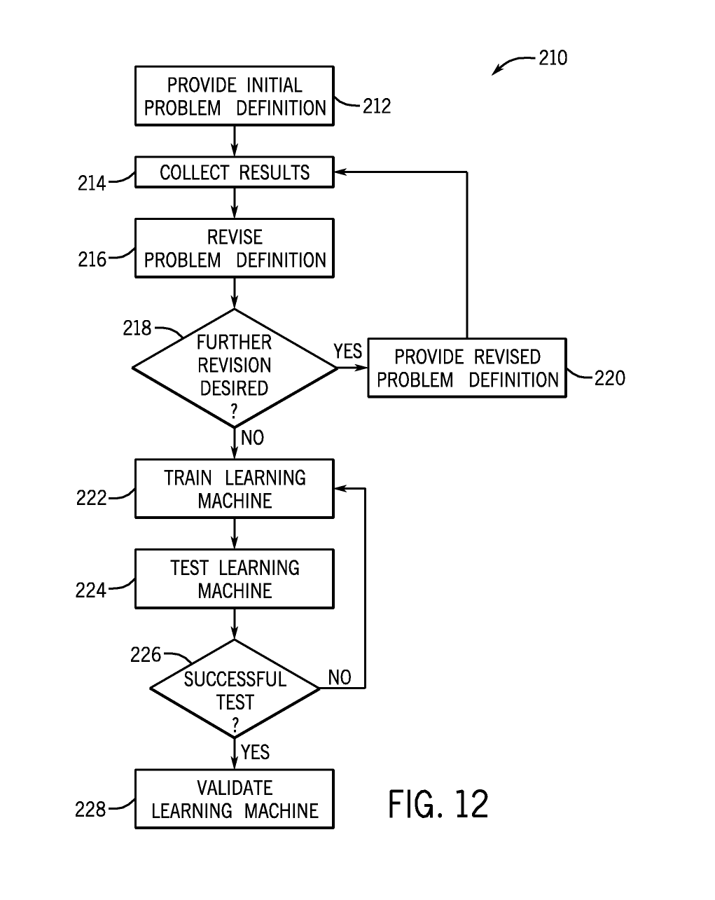

An exemplary machine training and validation method 210 is generally illustrated in FIG. 12 in accordance with one embodiment of the present invention. The method 210 begins with the provision of an initial problem definition in step 212. For instance, in one embodiment, volume computer-assisted reading (VCAR) system may be used to solve a detection problem based on an initial problem definition and to detect spherical shapes in medical data. Results may be collected from one or more VCAR systems, or other data acquisition systems, in a step 214 and used to revise the problem definition in step 216. If further problem definition revision is desired, additional data may be collected based on a revised problem definition, as generally indicated by the decision block 218 and step 220. Once the problem definition has been sufficiently revised, the data may be used to train and test a learning machine or algorithm in steps 222 and 224, respectively. The training and testing may be an iterative process, as generally indicated by decision block 226, and once such testing is successfully concluded the learning machine may be validated in step 228. It is noted that the ability of a learning algorithm to give an accurate diagnosis based on processed data may depend significantly on a suitable problem definition, as well as sufficient training and testing of the learning algorithm. Further, it is noted that the finding of features linked to a particular diagnostic outcome may be facilitated through the collection of field data regarding object detection and clinical outcomes with respect to such objects, and that in one embodiment such detection and outcome data is used to refine the problem definition and to train, test, and validate a learning algorithm, such as the classification algorithm discussed above.

Finally, based on the foregoing, it may be appreciated that the present technique allows for significant independence in the learning steps used to train the learning machine, including data independence, feature independence, and algorithmic independence. Notably, the data independence provides the flexibilities to change the types of data being integrated without impacting the generation of source-invariant features used for the learning process. Further, the feature independence provides flexibility in the generation of source-invariant processes without impacting the selection of particular learning algorithms, thus allowing the present technique to employ multiple algorithms during the learning process. Still further, the algorithmic independence provides the flexibilities of selecting and working with varieties of learning algorithms without impacting the results and, ultimately, the knowledge generated from these learning algorithms. Consequently, the independence afforded by the present technique may result in a learning process that is more flexible, more adaptable, more efficient, and more powerful than previous learning processes. Further, the identification and use of acquisition system-invariant features may reduce or eliminate the need to re-train a learning classification algorithm due to differing data sources or technological changes. Still further, in one embodiment, the present technique facilitates classification based on both acquisition-system invariant features as well as active EMR meta-data such that the classification of objects is based on holistic considerations.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system comprising:
a memory device having a plurality of routines stored therein;
a processor configured to execute the plurality of routines stored in the memory device, the plurality of routines comprising:
a routine configured to effect, when executed, receiving of input data from a data source;
a routine configured to effect, when executed, organizing of the input data;
a routine configured to effect, when executed, identifying of one or more features of an object of interest from the input data, wherein the identifying of the feature includes identifying one or more source-invariant characteristics of the object of interest;
a routine configured to effect, when executed, classifying of the object of interest via a learning algorithm, wherein the classifying of the object of interest is based, at least in part, on the one or more identified source-invariant characteristics; and
a routine configured to effect, when executed, outputting of results of the classification of the object of interest.

2. The system of claim 1, wherein the input data includes image data and non-image data.

3. The system of claim 2, wherein the classifying of the object of interest is based, at least in part, on both the image data and the non-image data.

4. The system of claim 1, wherein the data source includes an imaging system configured to acquire image data pertaining to a patient.

5. The system of claim 1, wherein the data source includes a database of patient information.

6. The system of claim 1, wherein the one or more source-invariant characteristics of the object of interest include geometric characteristics, textural characteristics, or density of the object of interest.

7. The system of claim 1, wherein the plurality of routines comprise a routine configured to effect, when executed, organizing of the results of the classification of the object of interest.

8. The system of claim 7, wherein the organizing of the results includes indexing the results, processing the indexed results, and generating at least one output.

9. The system of claim 8, wherein the outputting of the results includes outputting at least one of a graphical output or an alarm output.

10. The system of claim 1, wherein the outputting of the results includes one or more of:
providing an indication of the results to a user via a computing device;
transmitting the results to an automated tool for additional processing; or
storing the results for future output or processing.

11. A computer-implemented method comprising:
receiving image data from an imaging system;
organizing the image data into multiple objects of interest;
identifying source-invariant features of the multiple objects of interest;
classifying the multiple objects of interest via a learning algorithm into categories based, at least in part, on the identified source-invariant features; and
outputting a report based at least in part on data derived from the classification of one or more of the multiple objects of interest.

12. The computer-implemented method of claim 11, wherein classifying the multiple objects of interest via the learning algorithm is performed independent of source-varying features.

13. The computer-implemented method of claim 11, comprising:
receiving non-image data; and
classifying the multiple objects of interest via the learning algorithm into categories based, at least in part, on the non-image data as well as the identified source-invariant features.

14. The computer-implemented method of claim 11, wherein the learning algorithm includes a support vector machine.

15. A method comprising:
providing an initial problem definition to a medical institution, the initial problem definition including a process for predicting a diagnostic outcome regarding objects detected in medical image data through analysis of at least the medical image data;
receiving diagnostic data from the medical institution regarding a detected object in the medical image data;
comparing the diagnostic data with the predicted diagnostic outcome regarding the detected object;
revising the initial problem definition based, at least in part, on the comparison;
training a learning machine based, at least in part, on the diagnostic data received from the medical institution;
operating the learning machine to analyze a medical image and to generate a predicted diagnostic outcome with respect to an object detected in the medical image; and
outputting a report indicative of a result of the analysis of the medical image by the learning machine.

16. The method of claim 15, wherein training the learning machine comprises training a classification algorithm, further comprising distributing the classification algorithm for installation on an additional machine, such that the additional machine is configured to analyze medical images and generate predicted diagnostic outcomes via the classification algorithm.

17. The method of claim 16, wherein distributing the classification algorithm comprises at least one of:
transmitting the classification algorithm over a network; or
providing a computer-readable media having the classification algorithm encoded thereon.

18. The method of claim 17, wherein distributing the classification algorithm comprises distributing a computer program including the classification algorithm.

19. A manufacture comprising:
a computer-readable medium having executable instructions stored thereon, the executable instructions comprising:
instructions adapted to receive image data from an imaging system;
instructions adapted to organize the image data into multiple objects of interest;
instructions adapted to identify source-invariant features of the multiple objects of interest;
instructions adapted to classify the multiple objects of interest via a learning algorithm into categories based, at least in part, on the identified source-invariant features; and
instructions adapted to output a report based at least in part on data derived from the classification of one or more of the multiple objects of interest.

20. The manufacture of claim 19, wherein the computer-readable medium comprises a plurality of computer-readable media at least collectively having the executable instructions stored thereon.
